(19) United States
(12) Patent Application Publication
(10) Pub. No.: US 2004/0027913 A1
(43) Pub. Date: Feb. 12, 2004

(54) Mixing apparatus

(76) Inventor: Darrin John Cockbain, Ryton (GB)

Correspondence Address: LARSON & TAYLOR, PLC, 1199 NORTH FAIRFAX STREET, SUITE 900, ALEXANDRIA, VA, 22314, US

(21) Appl. No.: 10/216,169

(22) Filed: Aug. 12, 2002

(51) Int. Cl. B01F 7/26; B01F 15/02

(52) U.S. Cl. 366/169.2; 366/315

(57) ABSTRACT

Mixing apparatus comprises a container and a mixing mechanism mounted within the container, the mechanism including a driven shaft and a mixing disc mounted on the shaft to be rotatable therewith, the shaft being hollow and having mounted thereon a plurality of axially spaced projections some at least of which are provided with a bore therethrough communicating between the interior of the container and the hollow interior of the shaft, the lower end of the shaft being closed, the upper end of the shaft being adapted for connection to a source of liquid external of the container, whereby said liquid can be supplied through the hollow interior of the shaft and through the bores in the projections into the interior of the container.

### BACKGROUND OF THE INVENTION

This invention relates to industrial mixing apparatus, and has particular application to such apparatus for mixing powder-based materials such as adhesives, inks, paints and the like into homogeneous liquid solutions.

Our pending European patent application no. 0888811 discloses mixing apparatus comprising a container and a mixing mechanism mounted within the container, the mechanism including a driven shaft and a mixing disc mounted on said shaft, characterised in that the mixing disc is mounted on the shaft to be movable axially relative to the shaft and is so arranged that, on initial rotation of the shaft in one direction, the disc moves from a predetermined upper position on the shaft to a predetermined lower position on the shaft where it remains on continued rotation of the shaft in said one direction, and, on initial rotation of the shaft in the opposite direction, the disc moves from said predetermined lower position on the shaft to said predetermined upper position on the shaft where it remains on continued rotation of the shaft in said opposite direction.

It will be appreciated that, with such an arrangement, movement of the mixing disc between a lower normal mixing position at or adjacent one end of the driven shaft in the lower/central regions of the container, and a raised position at or adjacent the other end of the driven shaft in the upper regions of the container can be achieved merely by reversing the direction of rotation of the driven shaft. Thus, as and when it is necessary to ensure initial mixing or wetting out of powder being fed into the upper regions of the container, the shaft is driven in a direction to ensure movement of the mixing disc to its upper position thereon.

It is preferable that, after mixing a first material and prior to mixing a different second material, the interior of the container and the mixing mechanism therein are cleaned.

Conventionally such cleaning is effected by means of a pair of pipes projecting into the upper regions of the container and through which water or the like is fed under pressure, the pipes having rotatable heads thereon through which the water is sprayed into the interior of the container.

Such an arrangement suffers from a number of disadvantages. As well as being costly and complex to install, the pipes cannot project downwardly below the upper level of liquid to be mixed in the container. Accordingly it can be difficult to clean the lower regions of the container and the mixing mechanism therein.

### SUMMARY OF THE INVENTION

It would be desirable to be able to provide a cleaning system for mixing apparatus which overcame the aforementioned disadvantages, and in particular which was easy and economic to install, and which enabled more efficient cleaning of the interior of the container and the mixing mechanism then heretofore.

According to the present invention there is provided mixing apparatus comprising a container and a mixing mechanism mounted within the container, the mechanism including a driven shaft and a mixing disc mounted on the shaft to be rotatable therewith, characterised in that the shaft is hollow and has mounted thereon a plurality of axially spaced projections some at least of which are provided with a bore therethrough communicating between the interior of the container and the hollow interior of the shaft, the lower end of the shaft being closed, the upper end of the shaft being adapted for connection to a source of liquid external of the container, whereby said liquid can be supplied through the hollow interior of the shaft and through the bores in the projections into the interior of the container.

The liquid supplied through the shaft and the projections may be introduced to the container under pressure to clean the interior of the container, or may be introduced to the container to top-up the material being mixed within the container.

In a preferred embodiment of the invention, adjacent projections are axially and laterally spaced on the shaft to define a helical series of projections extending substantially the length of the shaft, the internal surface of the mixing disc having a corresponding helical groove formed therein to receive the projections, the arrangement being such that, on initial rotation of the shaft in one direction, the disc, guided by the projections, moves from a predetermined upper position on the shaft to a predetermined lower position on the shaft where it remains on continued rotation of the shaft in said one direction, and, on initial rotation of the shaft in the opposite direction, the disc, guided by the projections, moves from said predetermined lower position on the shaft to said predetermined upper position on the shaft where it remains on continued rotation of the shaft in said opposite direction.

It will be appreciated that, with such an arrangement, the projections on the shaft serve a dual function, firstly to guide the mixing disc in its axial movement relative to the shaft between its upper and lower positions, and secondly to enable the ingress of liquid, either for cleaning purposes or top-up purposes, into the interior of the container.

Conveniently the shaft carries abutment means thereon for engagement by the mixing disc to determine the upper and lower positions of the disc on the shaft, the helical series of projections preferably continuing upwardly beyond the upper abutment means.

Some of the projections may be provided with outlet nozzles adapted to direct liquid supplied through the shaft substantially radially of the container onto the defining interior walls of the container, and others of the projections may be provided with outlet nozzles adapted to direct liquid supplied through the shaft substantially axially of the container along the outer surface of the shaft.

### BRIEF DESCRIPTION OF THE DRAWINGS

FIG. 1 is a vertical section through mixing apparatus according to the invention, and

FIG. 2 is a detail of FIG. 1 to a larger scale.

### DESCRIPTION OF THE PREFERRED EMBODIMENT

Referring to the drawings, the illustrated apparatus comprises a conventional liquid container 2 with a lid 4 having a feed inlet for powder (not shown).

A mixing mechanism is indicated generally at 6 and comprises a shaft 8 which extends into the container 2 through a seal in the lid, the shaft 8 being driven by a reversible motor 10 through bearings and couplings 12. The motor 10, the drive shaft of which is at right angles to the shaft 8, may be electrically or hydraulically powered.

The shaft 8 carries a pair of stop members 14,16, the stop member 14 being secured to the shaft 8 adjacent the lower end of the shaft 8, and the stop member 16 being secured to the shaft 8 at an upper region of the shaft 8.

The shaft 8 is hollow, the upper end thereof extending beyond the coupling 12 for reasons which will become apparent, and the lower end being closed.

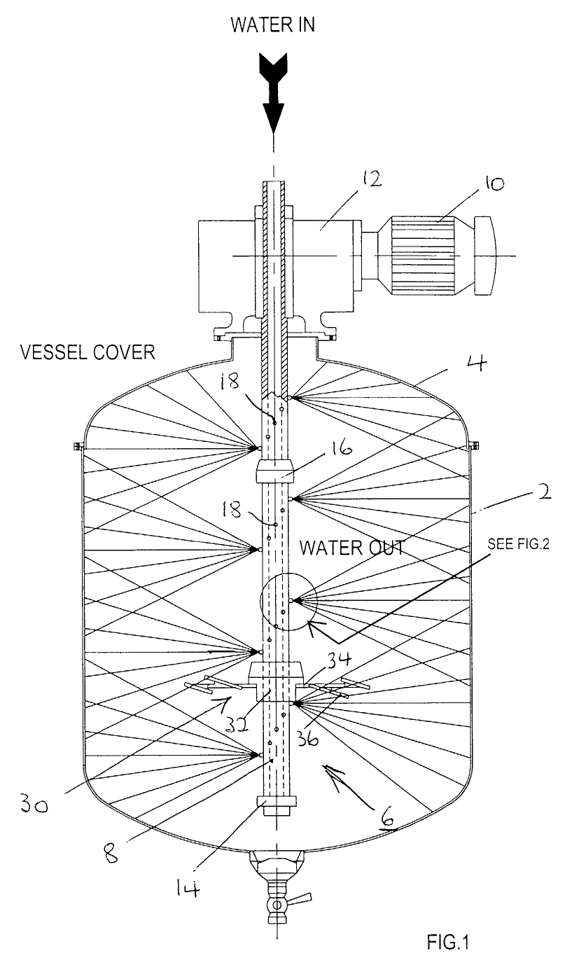

A plurality of axially and laterally spaced projections 18 are provided along the length of the shaft 8 to be disposed helically about the shaft 8 between the lower stop member 14 and the upper extent of that part of the shaft 8 within the container 2 as is apparent from FIG. 1.

Each projection 18 is located in an associated radial aperture 20 communicating with the hollow interior of the shaft 8, and is provided with a central bore 22 feeding from the associated aperture 20 to a head 24 of the projection 18 located on the surface of the shaft 8.

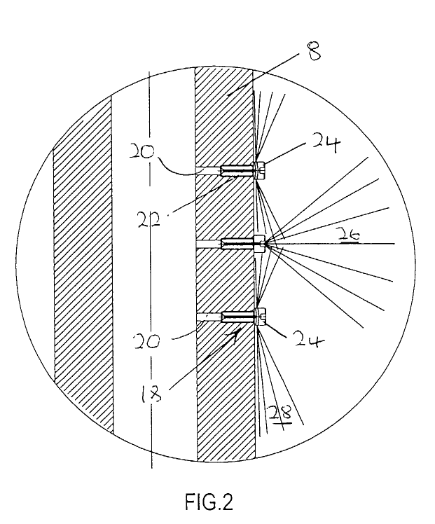

Some of the heads 24, for example the heads 24 of alternate projections 18, comprise nozzles configured to spray liquid fed thereto generally outwardly thereof substantially radially of the container towards the interior walls of the container 2 as indicated at 26 in FIG. 2, while others of the heads 24 comprise nozzles configured to spray liquid fed thereto generally axially of the shaft 8 as indicated at 28 in FIG. 2.

A mixing disc indicated generally at 30 is mounted on the shaft 8 between the stop members 14,16.

More particularly, the disc 30 includes a central hub 32 having a bore through which the shaft 8 freely passes, a helical groove being formed in the internal surface of the hub 32 to extend the length of the hub 32.

The groove in the hub 32 receives therein a series of the helically disposed projections 18 on the shaft 8 whereby the disc 30 is located on the shaft 8.

The disc 30 further includes a substantially flat, annular intermediate disc portion 34 from the radially outer regions of which extend a plurality of circumferentially-spaced blades 36. Each blade 36 is twisted relative to the disc portion 34 and has an outer edge located at an acute angle to the plane of the disc portion 34, each blade 36 extending symmetrically to each side of the plane of the disc portion 34.

The described mixing mechanism is located within the container 2 as shown in FIG. 1 with the shaft 8 located centrally and vertically and with the stop member 14 within the lower regions of the container 2 and with the stop member 16 within the upper regions of the container 2.

The apparatus operates as follows.

With the disc 30 abutting the lower stop member 14 and on rotation of the shaft 8 in an anticlockwise direction, the co-operation between the projections 18 on the shaft 8 and the groove in the hub 32 ensures that the disc 30 rotates with the shaft 8, while the configuration of the blades 36 of the rotating disc 30 is such that the forces applied thereto by a liquid medium within the container 2 tend to urge the disc 30 downwardly. Such movement is prevented by the stop member 14, and the disc 30 therefore rotates with the shaft 8 in this lower position to effect mixing of the contents of the container 2, typically a powder fed into the container 2 through the inlet to the container to be mixed with a liquid carrier within the container 2.

If it is desired to effect mixing within the upper regions of the container 2, for example to achieve wetting out of incoming powder fed to the container 2 through the inlet, the direction of rotation of the shaft 8 is reversed to clockwise. The forces applied to the rotating disc 30 are now such as to urge the disc 30 upwardly within the container 2, the result being that the disc 30 is rotated at a speed greater than that of the shaft 8 and moves upwardly relative to the shaft 8 along the series of helically disposed projections 18 until it abuts the stop member 16 which determines the limit of upward movement. On continued rotation of the shaft 8 in a clockwise direction, the disc 30 is rotated therewith in its upper position to effect mixing within the upper regions of the container 2.

When it is required to resume mixing in the lower regions of the container 2, the direction of rotation of the shaft is reversed again to anticlockwise and the disc 30 moves downwardly of the shaft 8 guided by the projections 18 until it abuts the stop member 14.

Between mixing different batches of materials, it is advisable to clean out the container 2 of a previous material. For this purpose, the hollow upper end of the shaft 8 external of the container 2 is adapted for attachment to a supply of cleaning fluid whereby said liquid can be fed under pressure down the hollow interior of the shaft 8 and into the container 2 through apertures 20, the bores 22 and the nozzles of the projections 18 to clean the interior surface of the walls of the container 2, the external surface of the shaft 8 and the mixing disc 30.

The projections 18 thus serve the dual function of guiding the mixing disc 30 on its movement upwardly and downwards relative to the shaft 8 between the stop members 14,16, and enabling cleaning liquid to be fed into the container.

The projections 18 feeding into the container 2 may be used, alternatively or additionally, to feed in liquid during the mixing process to supplement the contents of the container 2, the rotational speed of the shaft 8 and mixing disc 30 being reduced during such supplementary feeding.

Some only of the projections 18 may be provided with bores 22 and nozzles in the heads 24, the other projections 18 serving only to guide the mixing disc 30. In particular, the upper regions of the container 2 above the normal maximum level of the material being mixed usually require the most cleaning, and the projections 18 above the upper stop member 16 will incorporate the cleaning facility. The projections 18 below the stop member 16 may therefore not be bored, or some only of said projections 18 may be bored.

Clearly the precise arrangement will be chosen dependant upon circumstances.

Thus there is provided a cleaning system for a mixing apparatus which is conveniently and unobtrusively incorporated into the mixing mechanism of the apparatus whereby no separate or additional installation into the container is required, and which can be controlled and/or adjusted to provide effective and efficient cleaning of any or all of the interior walls of the container, the shaft and the mixing disc.

What I claim and desire to protect by Letters Patent:

1. Mixing apparatus comprising a container and a mixing mechanism mounted within the container, the mechanism including a driven shaft and a mixing disc mounted on the shaft to be rotatable therewith, the shaft being hollow and having mounted thereon a plurality of axially spaced projections some at least of which are provided with a bore therethrough communicating between the interior of the container and the hollow interior of the shaft, the lower end of the shaft being closed, the upper end of the shaft being adapted for connection to a source of liquid external of the container, whereby said liquid can be supplied through the hollow interior of the shaft and through the bores in the projections into the interior of the container.

2. Mixing apparatus as claimed in claim 1 in which the liquid supplied through the shaft and the projections is introduced to the container under pressure to clean the interior of the container.

3. Mixing apparatus as claimed in claim 1 in which liquid supplied through the shaft and the projections is introduced to the container to top-up the material being mixed within the container.

4. Mixing apparatus as claimed in claim 1 in which adjacent projections are axially and laterally spaced on the shaft to define a helical series of projections extending substantially the length of the shaft, the internal surface of the mixing disc having a corresponding helical groove formed therein to receive the projections, the arrangement being such that, on initial rotation of the shaft in one direction, the disc, guided by the projections, moves from a predetermined upper position on the shaft to a predetermined lower position on the shaft where it remains on continued rotation of the shaft in said one direction, and, on initial rotation of the shaft in the opposite direction, the disc, guided by the projections, moves from said predetermined lower position on the shaft to said predetermined upper position on the shaft where it remains on continued rotation of the shaft in said opposite direction.

5. Mixing apparatus as claimed in claim 4 in which the shaft carries abutment means thereon for engagement by the mixing disc to determine the upper and lower positions of the disc on the shaft.

6. Mixing apparatus as claimed in claim 5 in which the helical series of projections continues upwardly beyond the upper abutment means.

7. Mixing apparatus as claimed in claim 1 in which some of the projections are provided with outlet nozzles adapted to direct liquid supplied through the shaft substantially radially of the container onto the defining interior walls of the container, and others of the projections are provided with outlet nozzles adapted to direct liquid supplied through the shaft substantially axially of the container along the outer surface of the shaft.
